(19) United States
(12) Patent Application Publication
(10) Pub. No.: US 2006/0181593 A1
(43) Pub. Date: Aug. 17, 2006

(54) Image forming apparatus

(75) Inventor: Tetsuya Okano, Anjo-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/348,324

(22) Filed: Feb. 7, 2006

(30) Foreign Application Priority Data
Feb. 9, 2005 (JP) 2005033138

(51) Int. Cl. B41J 2/41; G11B 3/00

(52) U.S. Cl. 347/112

(57) ABSTRACT

An image forming apparatus includes a photoreceptor which forms an electrostatic image on a surface, a light exposure unit which forms the electrostatic image on the surface, a development unit which develops the electrostatic image, a belt member which transfers a developer deposited on the photoreceptor, a driving unit which rotationally drives the belt member, a removal unit which removes the developer, a pattern formation unit which forms a pattern on the belt member, a pattern detection unit which detects the pattern, a removal function stopping unit which prohibits removing the developer by stopping a developer removal function before the developer reaches a removal position or by maintaining stopping the developer removal function, and a drive control unit which causes the pattern detection unit to detect the pattern for a plurality of times by controlling the driving unit to rotate the belt member at least once.

### CROSS REFERENCE TO RELATED APPLICATION

This application claims priority from Japanese Patent Application No. 2005-033138, filed Feb. 9, 2005, the contents of which are hereby incorporated by reference into the present application.

### TECHNICAL FIELD

This invention relates to an image forming apparatus forming an image by an electrophotographic method. More specifically, this invention relates to an image forming apparatus which enables adjustment of a state of an image, such as a color shift, by forming a pattern for image quality inspection and detecting the image quality inspection pattern.

### BACKGROUND

Conventionally, an image forming apparatus including: a photoreceptor on whose surface an electrostatic image is formed responsive to light exposure; a light exposure unit for forming the electrostatic image on the surface of the photoreceptor by irradiating the photoreceptor with light; a development unit for developing the electrostatic image by depositing an developer on the electrostatic image formed on the surface of the photoreceptor; a belt member on which the developer deposited on the photoreceptor by the developing unit is conveyed, the belt member being in the form of an endless belt; a driving unit for rotationally driving the belt member a removal unit for removing the developer transferred on the belt member; a pattern formation unit for forming a pattern on the belt member; and a pattern detection unit for detecting the pattern formed on the belt member has been proposed.

In such an image forming apparatus, the light exposure unit forms the electrostatic image on the surface of the photoreceptor by irradiating the surface of the photoreceptor with light, and the developing unit develops the electrostatic image by depositing the developer on the electrostatic image. The developer used for developing the electrostatic image is transferred on the belt member which is rotationally driven by the driving unit and in the form of the endless belt. When a recording medium such as a sheet of paper is fed by placing the paper on a surface of the belt, the developer is transferred on the recording medium, thereby forming an image on the recording medium. Also, it is possible to form the image on the paper by conveying on the paper the developer which has been transferred on the belt member.

In the case where the image forming apparatus of the above-described type is provided with a plurality of photoreceptors for a plurality of colors of developers, lines which must be overlaid can sometimes be shifted from one another when the photoreceptors are misaligned. Accordingly, the pattern for image quality inspection (e.g. registration marks) is formed on the belt member by the pattern formation unit, so that it is possible to detect a degree of a color shift or the like by detecting the pattern by using the pattern detection unit. When the degree of the color shift or the like is detected, it is possible to perform excellent image formation by correcting a light exposure timing of the photoreceptor or the like in accordance with the color shift degree. The developer used for forming the pattern is usually removed by the removal unit after the detection by the pattern detection unit.

However, in such an image forming apparatus, a position of the pattern cannot be accurately detected in the case where a dust is deposited on the pattern to cause error or in the case where a noise is superimposed on a signal from a sensor during the pattern detection. Therefore, there has been proposed to increase accuracy of pattern position detection by detecting the pattern repeatedly by using a CCD having a plurality of pixels along a direction of conveyance of the pattern and moving the pattern by a very small distance (see, for example, JP-A-2000-19987). Also, there has been proposed to increase the pattern position detection accuracy by forming a pattern repeatedly and detecting the pattern repeatedly (see, for example, JP-A-2001-201896).

In the case of the apparatus of JP-A-2000-19987, a production cost of the apparatus is increased since the CCD having the plural pixel is required as the pattern detection unit. In the case of the apparatus of JP-A-2001-201896, a running cost of the apparatus is increased due to a waste of the developer since it is necessary to form the pattern repeatedly. Therefore, an object of this invention is to provide an image forming apparatus which enables the use of a simple sensor as the pattern detection unit and is capable of detecting a position of a pattern accurately without forming the pattern repeatedly.

### SUMMARY

According to an aspect of the present invention, an image forming apparatus includes a photoreceptor which forms an electrostatic image on a surface responsive to light exposure, a light exposure unit which forms the electrostatic image on the surface of the photoreceptor by exposing the photoreceptor, a development unit which develops the electrostatic image by depositing a developer on the electrostatic image formed on the surface of the photoreceptor, a belt member which transfers the developer deposited on the photoreceptor by the developing unit, the belt member being in a form of an endless belt, a driving unit which rotationally drives the belt member, a removal unit which removes the developer transferred on the belt member, a pattern formation unit which forms a pattern on the belt member by controlling the light exposure unit, a pattern detection unit which detects the pattern formed on the belt member, a removal function stopping unit which prohibits removing the developer constituting the pattern by stopping a developer removal function of the removal unit before at least the developer constituting the pattern reaches a removal position of the removal unit or by maintaining a state in which the developer removal function is stopped when the pattern is formed on the belt member, and a drive control unit which causes the pattern detection unit to detect the pattern for a plurality of times by controlling the driving unit to rotate the belt member at least once when the pattern is formed on the belt member.

With such constitution, when the pattern for image quality inspection is formed on the belt member, the removal function stopping unit stops the developer removal function of the removal unit before the developer constituting the pattern reaches the removal position or maintains the removal function stopped state to prohibit the removal of the developer constituting the pattern. Also, when the developer removal function is stopped as described above, the drive control unit causes the pattern detection unit to detect the pattern for the plurality of times by controlling the driving unit in such a manner that the driving unit rotationally drives the belt member to cause the belt member to rotate at least once.

During the period in which the removal function stopping unit prohibits the removal unit from removing the developer, the pattern formed on the belt member remains on the same position on the belt member despite the rotation of the belt member, so that the pattern is detected by the pattern detection unit for the plural times. That is, though the pattern is formed only once and the pattern is detected by the pattern detection unit which performs detection of the only one point, this image forming apparatus detects the pattern for the plurality of times to thereby increase detection accuracy.

According to this embodiment, it is possible to use a simple sensor as the pattern detection unit; it is possible to accurately detect the position of the pattern without forming the pattern for a plurality of times; and it is possible to detect a color shift or the like without increasing a production cost or a running cost of the apparatus. Also, though a variation in pattern position can occur in the case of forming a plurality of patterns and detecting each of the patterns, this embodiment is free from such variation. Further, though a variation in detection ability can occur among the sensors (or pixels) in the case of using a pattern detection unit employing a multiple of sensors, this embodiment is also free from such variation. Furthermore, since it is unnecessary to rotate the belt member in a reverse direction as described later in this specification, it is possible to simplify a belt driving system.

Various modes maybe used for the removal function stopping unit in this embodiment, and the removal function stopping unit may stop the removal function or may maintain the removal function stopped state by separating the removal unit from the belt member or maintaining the state in which the removal unit is separated from the belt member. In the case of separating the removal unit from the belt member, it is possible to reliably prohibit the removal of the developer which constitutes the pattern. Therefore, in this case, there is achieved an effect of more reliably performing the pattern detection for the plurality of times.

Also, in this case, the removal function stopping unit may separate the removal unit from the belt member at a timing except for that during the pattern detection by the pattern detection unit. An error can occur during the pattern detection due to a vibration of the belt caused when the removal unit is separated from the belt member. Therefore, the pattern detection accuracy is further increased by separating the removal unit from the belt member at a timing other than that during the pattern detection.

According to another aspect of this invention, an image forming apparatus includes a photoreceptor which forms an electrostatic image on a surface responsive to light exposure, a light exposure unit which forms the electrostatic image on the surface of the photoreceptor by exposing the photoreceptor, a development unit which develops the electrostatic image by depositing a developer on the electrostatic image formed on the surface of the photoreceptor, a belt member which transfers the developer deposited on the photoreceptor by the developing unit, the belt member being in a form of an endless belt, a driving unit which rotationally drives the belt member, a removal unit which removes the developer transferred on the belt member, a pattern formation unit which forms a pattern on the belt member by controlling the light exposure unit, and a pattern detection unit which detects the pattern formed on the belt member. The removal unit is disposed at a position where the removal unit does not start removing the developer constituting the pattern until a pattern detection by the pattern detection unit is completed. The image forming apparatus further includes a drive control unit which when the pattern is formed on the belt member controls the driving unit to cause the belt member to rotate in a reverse direction at a timing after the completion of the pattern detection by the pattern detection unit and before the removal unit starts removing the developer constituting the pattern, and to cause the belt member to rotate the belt member in a positive direction after disposing the pattern short of a detection position of the pattern detection unit, thereby causing the pattern detection unit to detect the pattern for a plurality of times.

With such constitution, the removal unit is disposed at the position where the removal unit does not start removing the developer constituting the pattern until the pattern detection unit completes the pattern detection. The drive control unit controls the driving unit when the pattern is formed on the belt member in such a manner as described below. That is, the drive control unit causes the belt member to rotate in the reverse direction at a timing after the completion of the pattern detection by the pattern detection unit and before the removal unit starts the removal of the developer constituting the pattern so that the belt member rotates in the positive direction after the pattern is disposed short of the detection position of the pattern detection unit. With such driving control, the drive control unit causes the pattern detection unit to detect the pattern for the plurality of times.

As described above, even when the pattern is formed only once to be detected by the pattern detection unit which performs detection of the only one point, this image forming apparatus detects the pattern for the plurality of times thereby to increase detection accuracy, too. Therefore, according to this embodiment, it is possible to use a simple sensor as the pattern detection unit; it is possible to accurately detect the position of the pattern without forming the pattern for a plurality of times; and it is possible to detect a color shift or the like without increasing a production cost or a running cost of the apparatus.

Also, though a variation in pattern position can occur in the case of forming a plurality of patterns and detecting each of the patterns, this embodiment is free from such variation. Further, though a variation in detection ability can occur among the sensors (or pixels) in the case of using a pattern detection unit employing a multiple of sensors, this embodiment is also free from such variation. Furthermore, since it is possible to detect the pattern for the plurality of times without rotating the belt member for a plurality of times, it is possible to increase a pattern detection speed. Also, since it is unnecessary to use the removal function stopping unit, it is possible to simplify the constitution of the apparatus.

According to still another aspect of this invention, an image forming apparatus includes a photoreceptor which forms an electrostatic image on a surface responsive to light exposure, a light exposure unit which forms the electrostatic image on the surface of the photoreceptor by exposing the photoreceptor, a development unit which develops the electrostatic image by depositing a developer on the electrostatic image formed on the surface of the photoreceptor, a belt member which transfers the developer deposited on the photoreceptor by the developing unit, the belt member being in a form of an endless belt, a driving unit which rotationally drives the belt member, a removal unit which removes the developer transferred on the belt member, a pattern formation unit which forms a pattern on the belt member by controlling the light exposure unit, a pattern detection unit which detects the pattern formed on the belt member, a removal function stopping unit which prohibits removing the developer constituting the pattern by stopping a developer removal function of the removal unit before at least the developer constituting the pattern reaches a removal position of the removal unit or by maintaining a state in which the developer removal function is stopped when the pattern is formed on the belt member, and a drive control unit which when the pattern is formed on the belt member controls the driving unit to cause the belt member to rotate in a reverse direction after the completion of the pattern detection by the pattern detection unit, and to cause the belt member to rotate the belt member in a positive direction after disposing the pattern short of a detection position of the pattern detection unit, thereby causing the pattern detection unit to detect the pattern for a plurality of times.

With such constitution, the removal function stopping unit stops the developer removal function of the removal function before the developer constituting the pattern reaches the removal position of the removal unit or maintains the removal function stopped state to prohibit the removal of the developer constituting the pattern. Also, when the developer removal function is stopped as described above, the drive control unit causes the pattern detection unit to detect the pattern for the plurality of times by controlling the driving unit in such a manner as to cause the belt member to rotate in the reverse direction after the completion of the pattern detection by the pattern detection unit and to rotate in the positive direction after the pattern is disposed short of the detection position of the pattern detection unit.

As described above, even when the pattern is formed only once to be detected by the pattern detection unit which performs detection of the only one point, this image forming apparatus detects the pattern for the plurality of times thereby to increase detection accuracy, too. Therefore, according to this embodiment, it is possible to use a simple sensor as the pattern detection unit; it is possible to accurately detect the position of the pattern without forming the pattern for a plurality of times; and it is possible to detect a color shift or the like without increasing a production cost or a running cost of the apparatus.

Also, though a variation in pattern position can occur in the case of forming a plurality of patterns and detecting each of the patterns, this embodiment is free from such variation. Further, though a variation in detection ability can occur among the sensors (or pixels) in the case of using a pattern detection unit employing a multiple of sensors, this embodiment is also free from such variation. Furthermore, since it is possible to detect the pattern for the plurality of times without rotating the belt member for a plurality of times, it is possible to increase a pattern detection speed. Also, since this embodiment is free from restriction on the position of the removal unction stopping unit, it is possible to readily downsize the apparatus.

Various modes maybe employed also for the removal function stopping unit in this embodiment, and the removal function stopping unit may stop the removal function or may maintain the removal function stopped state by separating the removal unit from the belt member or maintaining the state in which the removal unit is separated from the belt member. In the case of separating the removal unit from the belt member, it is possible to reliably prohibit the removal of the developer constituting the pattern. Therefore, in this case, an effect of more reliably performing the pattern detection for the plurality of times is achieved.

Also, in this case, the removal function stopping unit may separate the removal unit from the belt member at a timing except for that during the pattern detection by the pattern detection unit. An error can occur during the pattern detection due to a vibration of the belt caused when the removal unit is separated from the belt member. Therefore, the pattern detection accuracy is further increased by separating the removal unit from the belt member at the timing other than that during the pattern detection.

The embodiment of switching between the directions of rotation of the belt member may further include a detaching unit for detaching the photoreceptor from the belt member when the drive control unit causes the belt member to rotate in the reverse direction. In this case, it is possible to more excellently prevent the photoreceptor from being damaged due to a contact with the belt member rotating in the reverse direction.

The embodiment of switching between the directions of rotation of the belt member may further include a photoreceptor reverse rotation unit for rotating the photoreceptor in the reverse direction when the drive control unit causes the belt member to rotate in the reverse direction. In this case, too, it is possible to more excellently prevent the photoreceptor from being damaged due to a contact with the belt member rotating in the reverse direction.

In the embodiment of switching between the directions of rotation of the belt member, the pattern detection unit may detect the pattern during a period in which the drive control unit causes the belt member to rotate in the reverse direction. In this case, since the pattern is detected when the belt is rotating in the reverse rotation, it is possible to further increase the pattern detection accuracy by increasing the number of pattern detections.

### BRIEF DESCRIPTION OF THE DRAWINGS

FIG. 1 is a schematic sectional view showing an internal structure of a color laser printer to which this invention is applied;

FIG. 2 is a diagram for illustrating a structure of a toner removal unit of the printer;

FIG. 3 is a block diagram showing a constitution of a control system of the printer;

FIG. 4 is a flowchart showing a processing executed by the control system;

FIGS. 5A to 5E are schematic diagrams showing an operation of the printer according to the processing;

FIG. 6 is a diagram illustrating a structure of a modification example of the toner removal unit;

FIG. 7 is a flowchart showing a modification example of the processing;

FIGS. 8A to 8E are schematic diagrams showing an operation of the printer according to the processing.

FIG. 9 is a flowchart showing a modification example of the processing; and

FIGS. 10A to 10E are schematic diagrams showing an operation of the printer according to the processing.

### DETAILED DESCRIPTION OF THE PREFERRED EMBODIMENTS

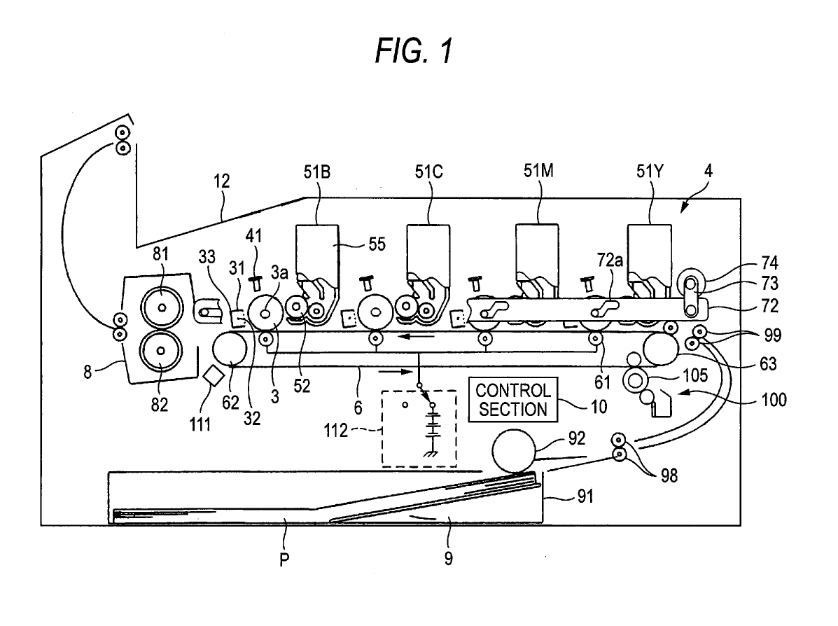

Hereinafter, embodiments of this invention will be described with reference to the drawings. FIG. 1 is a schematic sectional view showing an internal structure of a color laser printer (hereinafter simply referred to as printer) 1 as an image forming apparatus to which this invention is applied.

The printer 1 shown in FIG. 1 has a toner image forming unit 4, a sheet conveying belt 6 serving as a belt member, a fixing unit 8, a sheet feeding unit 9, a stacker 12, and a control unit 10 and forms an image of four colors on a sheet P serving as a recording medium in accordance with externally input image data.

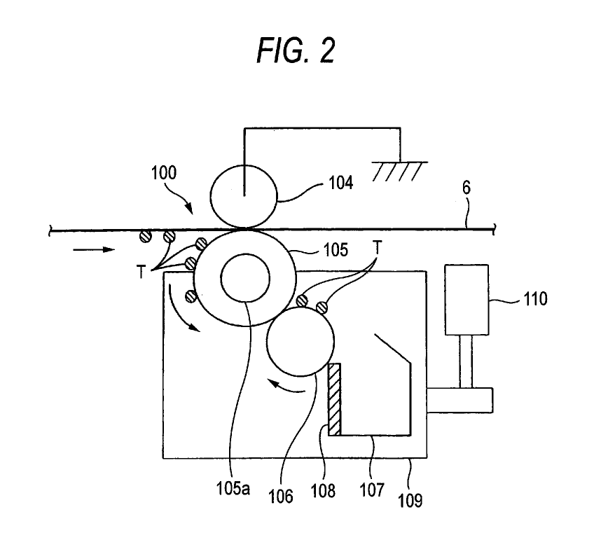

The toner image forming unit 4 is provided with four development units 51Y, 51M, 51C, and 51B each of which contains a toner T (equivalent to a developer; see FIG. 2). The colors of the toners T are yellow, magenta, cyan, and black. Each of the development units 51Y, 51M, 51C, and 51B is provided with a photosensitive drum 3 serving as a photoreceptor, a charger 31 for uniformly charging the photosensitive drum 3, and a scanner unit 41 serving as a light exposure unit for forming an electrostatic image in accordance with the image data by irradiating a surface of the photosensitive drum 3 after the charging with laser light. Almost all of component parts of the scanner unit 41 are omitted in FIG. 1, or, only a component part from which the laser light is emitted is shown in FIG. 1.

Hereinafter, structures of the component parts will be described in detail. In the following description, an alphabet of any one of Y for yellow, M for magenta, C for cyan, B for black is added to a reference number when it is necessary to indicate the color. Such alphabet is omitted when it is unnecessary to indicate the color.

Each of the photosensitive drums 3 in the toner image formation unit 4 is rotatable and formed of a member having a substantially cylindrical shape, and the four photosensitive drums 3 are aligned at a substantially constant interval along a horizontal direction. As the member having a substantially cylindrical shape, a member having a substrate made from aluminum and a positively charged photosensitive layer formed on the substrate is used, for example. The substrate is grounded on a ground line of the printer 1.

The charger 31 is a so-called scorotoron type charger and provided with a charging wire 32 facing to the photosensitive drum 3 and extending in a width direction of the photosensitive drum 3 and a shield case 33 housing the charging wire 32 and having an opening formed on a side thereof facing to the photosensitive drum 3. The charger charges the surface of the photosensitive drum 3 (e.g. to +700V) by applying a high voltage to the charging wire 32. The shield case 33 has a structure wherein a grid is provided at the opening facing to the photosensitive drum 3, and the surface of the photosensitive drum 3 is charged to a potential substantially the same as a grid voltage by applying a predetermined voltage to the grid.

The scanner unit 41 is disposed on each of the photosensitive drums 3 at a position downstream from the charger 31 in a rotation direction of the photosensitive drum 3. The scanner unit 41 emits the laser light from a light source for one color of the externally input image data to perform laser light scanning with the use of a mirror surface of a polygon mirror or the like which is rotationally driven by a polygon motor to irradiate the surface of the photosensitive drum 3 with the laser light.

When the scanner unit 41 irradiates the surface of the photosensitive drum 3 with the laser light according to the image data, a surface potential of the irradiated part is reduced (to +150 to +200 V) to form an electrostatic image on the surface of the photosensitive drum 3.

Each of the development units 51Y, 51M, 51C, and 51B has a structure wherein the development case 55 housing the toner T is provided with a development roller 52 serving as a developer, and the development roller 52 is disposed at a position downstream from the scanner unit 41 with respect to the rotation direction of the photosensitive drum 41 in such a fashion as to contact the photosensitive drum 3. Each of the development units 51 positively charges the toner T to supply the toner T as a uniform thin layer to the photosensitive drum 3 and causes the positively charged electrostatic image formed on the photosensitive drum 3 to carry the positively charged toner T at the contact part of the development roller 52 and the phoosentive drum 3 by the reverse development method, thereby developing the electrostatic image.

The development roller 52 is made from a base material such as an electroconductive silicone rubber and has a cylindrical shape, and a coating layer made from a resin containing fluorine or a rubber material is formed on a surface of the development roller 52. The toner T housed in the development case 55 is a positively charged nonmagnetic one-component toner, and a yellow toner, a magenta toner, a cyan toner, and a black toner are housed in the development unit 51Y, the development unit 51M, the development unit 51C, and the development unit 51B.

A sheet feed unit 9 is disposed at a lowermost part of the apparatus and provided with a housing tray 91 for housing recording sheets P and a pickup roller 92 for feeding the recording sheets P. The recording sheets P housed in the housing tray 91 are fed from the sheet feed unit 9 one by one by the pickup roller 92 to be sent to a sheet conveying belt 6 via registration rollers 99.

The sheet conveying belt 6 has a width which is narrower than that of the photosensitive drum 3 and is in the from of an endless belt so as to run integrally with the recording sheet P by carrying the recording sheet P thereon. The sheet conveying belt 6 is wrapped around a driving roller 62 and a driven roller 63. Transfer rollers 61 are provided in the vicinity of the positions opposed to each of the photosensitive drums 3 in such a fashion as to sandwich the sheet conveying belt 6. The sheet conveying belt 6 sequentially conveys the recording sheets P sent from the registration rollers 99 to the nips between the photosensitive drums 3 in such a fashion that a surface thereof opposed to each of the photosensitive drums 3 moves from the right hand side of the drawing to the left hand side of the drawing as shown in FIG. 1 by rotation of the driving roller 62, thereby conveying the recording sheets P to the fixing unit 8.

A cleaning roller 105 serving as a removal unit is disposed at a position where the sheet conveying belt 6 is turned around by the driving roller 62 and close to the driven roller 63. Further, a detection sensor 11 serving as a pattern detection unit is provided at a position at which the detection sensor 11 is opposed to the sheet conveying belt 6 on the driving roller 62. The detection sensor 11 may be a reflection type sensor having a light emitting unit and a plurality of light receiving units and distinguishing colors by a reflection angle of light (e.g. trade name GP2TC2 which is manufactured by Sharp, Co., Ltd.).

FIG. 2 is a diagram for illustrating a structure of the toner removal unit 100 provided with the cleaning roller 105 in detail. As shown in FIG. 2, the cleaning roller 105 has a shaft member 105a extending in a width direction of the sheet conveying belt 6, and a foamed material made form silicone surrounding the shaft ember 105a. The cleaning roller 105 is provided in such a fashion that it rotates with being in contact to the sheet conveying belt 6 when a predetermined bias is applied between the cleaning roller 105 and a metallic electrode roller 104 disposed at a position opposed to the cleaning roller 105 across the sheet conveying belt 6. With this bias, the toner T deposited on the sheet conveying belt 6 is removed by the cleaning roller 105. For instance, when the electrode roller 104 is connected to the ground line and a bias (e.g. −1200 V) having a polarity opposite to that of the toner T is applied to the cleaning roller 105, the toner T is attracted by the cleaning roller 105 to be removed. The cleaning roller 105 is driven by a driving unit (not shown) in such a manner that a part of the cleaning roller 105 at which the cleaning roller 105 contacts the sheet conveying belt 6 is in a direction reverse to a direction in which the sheet conveying belt 6 is turned.

The cleaning roller is provided with a collection roller 106 made from a metal (such as a nickelized iron material or a stainless material) for removing the toner T adhered to the cleaning roller 105 and a retention box (retention container) 107 for retaining the toner T removed from the cleaning roller 105. A cleaning blade 108 made from a rubber is abutted to the collection roller 106 to scratch off the toner T adhered to the collection roller 106.

The above-described constitution of a portion from the cleaning roller 105 to the retention box 107 is housed in a housing 109 which is moved vertically by a solenoid 110. Accordingly, the cleaning roller 105 contacts the sheet conveying belt 6 when the housing 109 is raised by shrinking of the solenoid 110, while the cleaning roller 105 is detached form the sheet conveying belt when the housing is lowered by elongation of the solenoid 110.

Referring back to FIG. 1, the transfer roller 61 transfers the toner image formed on the photosensitive drum 3 on the recording sheet P conveyed by the sheet conveying belt 6 when a transfer bias (e.g. −10 to −15 μA) which has a polarity reverse is to that of the toner T is applied between the transfer roller 61 and the photosensitive drum 3 by a power source 112 of a negative voltage.

The fixing unit 8 is provided with a thermal roller 81 and a pressure roller 82. The thermal roller 81 and the pressure roller 82 sandwiches the recording sheet P on which the toner image has been transferred as they convey the recording sheet P, so that the toner image is fixed on the recording sheet P by heating and pressurizing.

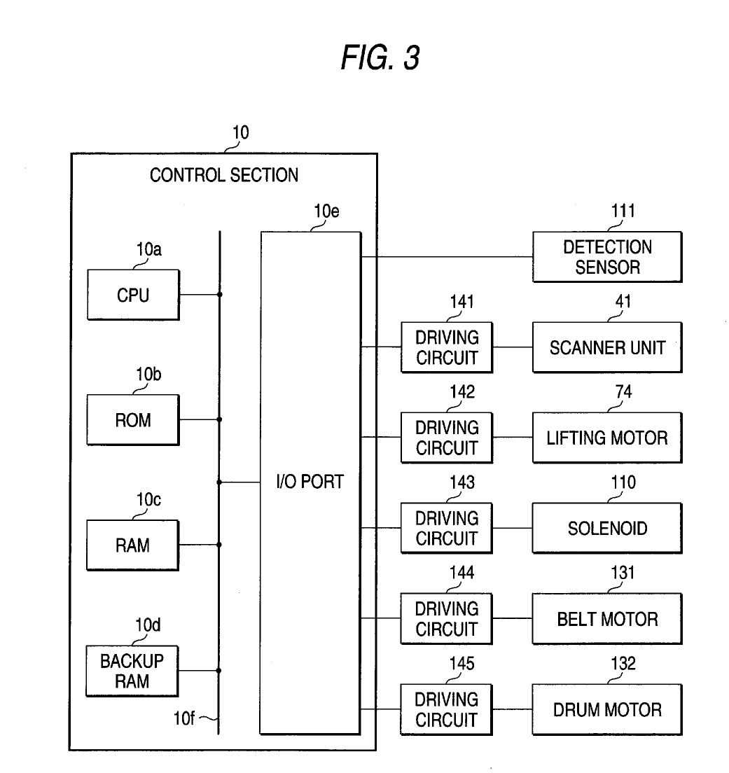

The stacker 12 is formed on a top face of the printer 1. The stacker 12 is disposed at a discharge side of the fixing unit 8 to retain the recording sheets P discharged from the fixing unit 8. The control unit 10 is provided with a controller using a known CPU 10a (see FIG. 3) or the like as described later in this specification and controls an overall operation of the printer 1.

The photosensitive drums 3 are held in such a fashion as to move upward so that the photosensitive drums 3 are detached from the sheet conveying belt 6 and positioned by a moving member 72 serving as a detaching unit provided in such a fashion as to stride the photosensitive drums 3. The moving member 72 is formed of a plate-like member having a length sufficient for striding all of the photosensitive drums 3 and held in such a fashion as to move rightward and leftward in FIG. 1. The moving member 72 is provided with four introduction holes 72a extending in a horizontal direction and having a substantially clank shape, and shafts 3a provided on a longitudinal side of the photosensitive drums 3 are fitted to the introduction holes 72.

The moving member 72 is provided with a lifting motor 74 via a link 73 for converting a rotational force into a horizontal force, and the lifting motor 74 rotates responsive to an instruction signal from the control unit 10 to move the moving member 72 to right or left. When the moving member 72 is moved to the left, the shaft 3a of each of the photosensitive drum 3 moves upward along the substantially clank shape of the introduction hole 72a along with leftward movement of the introduction hole 72a, so that the photosensitive drum 3 is detached from the sheet conveying belt 6. In contrast, when the moving member 72 is moved to the right, each of the photosensitive drums 3 contacts the sheet conveying belt 6. The image formation is normally performed in the state where the photosensitive drums 3 contact the sheet conveying belt 6.

An operation of forming an image on recording sheets P in the printer 1 having the above-described constitution according to this embodiment is as follows.

One of the recording sheets P is supplied from the sheet feeding unit 9 by the pickup roller 92, so that the recording sheet P is sent to the sheet conveying belt 6 via the transfer roller 98 and the registration rollers 99. Next, the surface of one of the photosensitive drums 3 (photosensitive drum 3Y) disposed at the rightmost position in FIG. 1 is uniformly charged by the charger 31 and then exposed to light by the scanner unit 41 based on externally input image data for yellow, so that an electrostatic image is formed as described above. Then, a yellow toner T which has been positively charged in the development unit 51Y is supplied to the surface of the photosensitive drum 3Y to perform development. The thus-formed toner image is transferred on the recording sheet P conveyed by the sheet conveying belt 6 by the transfer roller 61 to which the transfer bias has been applied.

The recording sheet P is then conveyed to positions at which the recording sheet P faces to the photosensitive drums 3 for magenta, cyan, and black in this order, so that toner images are formed on the surfaces of the photosensitive drums 3 in the same manner as in the yellow toner T. The toner images are transferred on the recording sheet P by the transfer roller 61 in an overlapping manner. The toner images of the four colors are fixed on the recording sheet P in the fixing unit 8 to be discharged on the stacker 12.

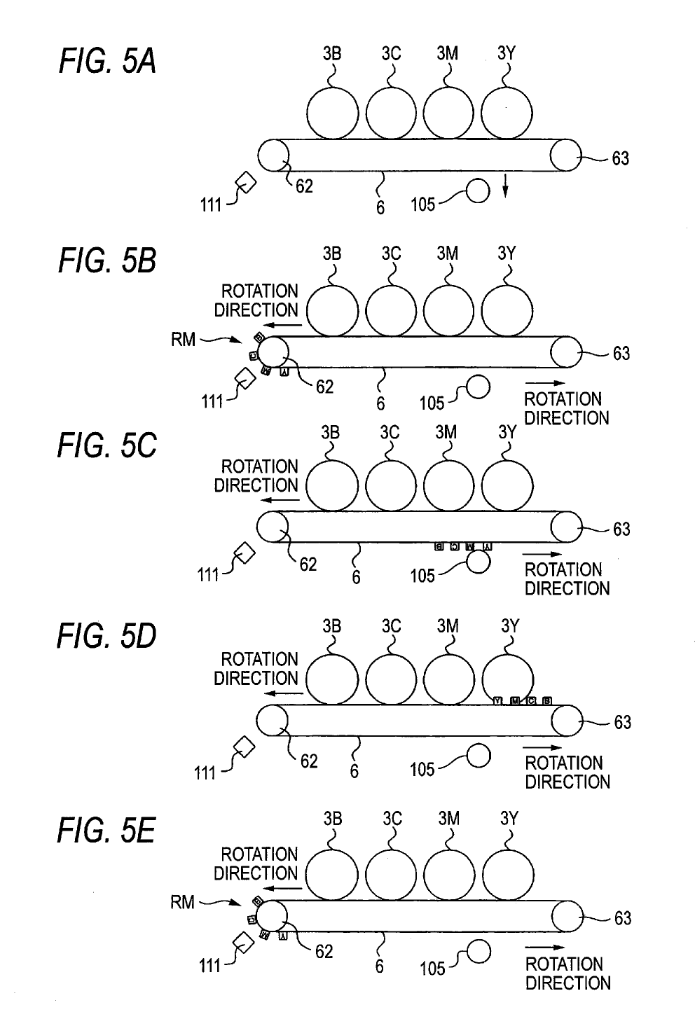

In the printer 1, registration marks RM (see FIGS. 5A to 5E) are formed by using the four color toners on the sheet conveying belt 6 at initialization such as when the power is input or after a jam processing, so that the detection sensor 111 detects a state of the registration marks RM. Hereinafter, the detection processing will be described in detail.

FIG. 3 is a block diagram showing a constitution of a control system of the printer 1. The control unit 10 is a microcomputer provided with the CPU 10a, a ROM 10b, a RAM 10c, a backup RAM 10d, an I/O port 10e, and a bus 10f for connecting the component parts 10a to 10e. A detection signal from the detection sensor 111 is input to the I/O port 10e of the control unit 10. Further, the I/O port 10e outputs driving signals to the scanner unit 41, the lifting motor 74, and the solenoid 110, driving signals to a belt motor 131 serving as a driving unit for driving the sheet conveying belt 6 via the driving roller 62, and driving signals to a drum motor 132 serving as a photoconductor reverse rotation unit for driving the photosensitive drums 3 via driving circuits 141, 142, 143, 144, and 145.

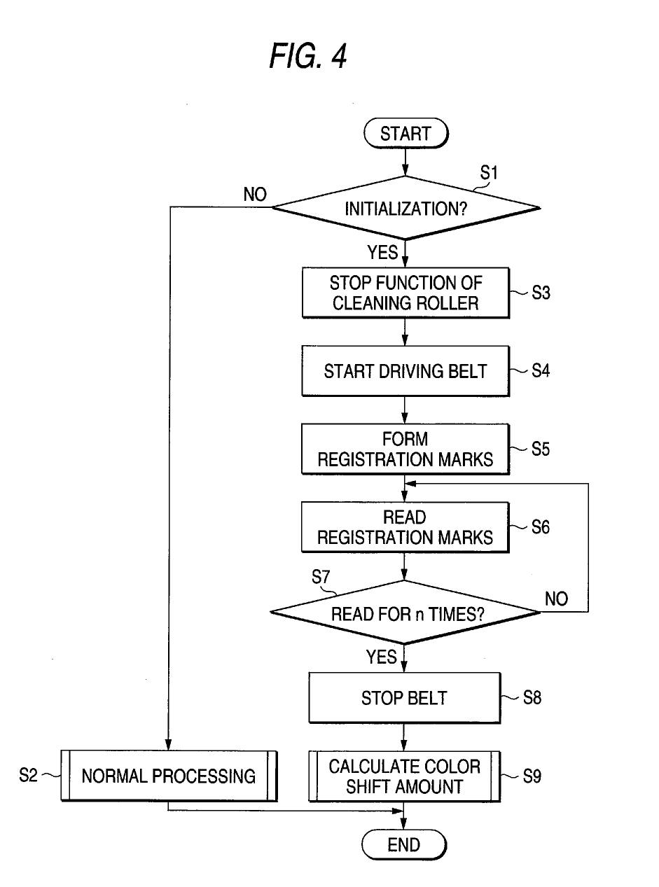

FIG. 4 is a flowchart showing a processing executed by the CPU 10a based on a program stored in the ROM 10b. When the processing is started, it is judged whether or not it is the initializing time such as when the power is input or after a jam processing in S1 (S stands for step; the same applies to the following description). Since a reset signal or a signal representing a completion of the jam processing is input to the CPU 10a, the above judgment is performed based on absence or presence of such input.

When it is not the initializing time (S1: NO), an ordinary processing such as image formation on the recording sheet P based on input data is performed in S2 to terminate the processing. In turn, when it is the initializing time (S1: YES), the function of the cleaning roller 105 is stopped in S3. That is, the solenoid 110 is elongated to separate the cleaning roller 105 from the sheet conveying belt 6.

In S4, when an instruction signal is sent to the belt motor 131, a positive direction driving of the sheet conveying belt 6 is started. In SS, when instruction signals are sent to the scanner unit 41 and the drum motor 132, registration marks RM are formed on the sheet conveying belt 6. In S6, the registration marks RM are read via the detection sensor 111.

When the reading of the registration marks RM is finished in S6, the process proceeds to S8 to judge whether or not the reading was performed for a predetermined times (n times: n>2). In the case where the reading has not been performed for n times (S7: NO), the process returns to S6 to perform the reading of the registration marks RM again.

Hereinafter, the processing of from S3 to S7 will be described using a block diagram of FIGS. 5A to 5E. As shown in FIG. 5A, the cleaning roller 105 is separated from the sheet conveying belt 6 in S3. In S4, the rotation of the sheet conveying belt 6 is started, and the toners T are transferred from the photosensitive drums 3Y, 3M, 3C, and 3B to the surface of the sheet conveying belt 6, so that the registration marks RM are formed. In FIGS. 5A to 5E, parts corresponding to the colors of yellow, magenta, cyan, and black are represented by Y, M, C, and B.

As shown FIG. 5B, the registration marks RM are read when they are faced to the detection sensor 111 by the processing of S6. The sheet conveying belt 6 is continuously driven after the reading (see S4), so that the registration marks RM are faced to the cleaning roller 105 as shown in FIG. 5C after facing to the detection sensor 111. As described in the foregoing, since the cleaning roller 105 is separated from the sheet conveying belt 6, the toners T constituting the registration marks RM are not removed and continues to rotate integrally with the sheet conveying belt 6.

Then, as shown in FIG. 5D, the registration marks RM pass under the photosensitive drums 3. Since the transfer bias has been applied to the photosensitive drums 3, the toners T constituting the registration marks RM continue the rotation without being reversely transferred on the photosensitive drums 3, so that the registration marks are read again by the detection sensor 111 as shown in FIG. 5E. In order to more excellently prevent a reverse transfer of the toners T in a state shown in FIG. 5D, an instruction signal for separating the photosensitive drums 3 from the sheet conveying belt 6 may be sent to the lifting motor 74.

Referring back to FIG. 4, when the registration marks RM have been read for n times (S7: YES), the sheet conveying belt 6 is stopped in S8, and then a color shift amount is calculated in S9 to terminate the processing.

Any of known various calculation methods may be used for the calculation of the color shift amount in S9. It is possible to calculate a color shift amount of each of the registration marks RM read for the n times, and any of various methods described below may be used for obtaining a true color shift amount from the n color shift amounts. The methods may be a calculation of an average value of the n color shifts, a calculation of an average value of the n color shifts after eliminating an abnormal value, a calculation of an intermediate value of the n color shifts, a calculation of an intermediate value of the n color shifts after eliminating an abnormal value, and the like. A threshold value for detecting the abnormal value, i.e. a range of normal values, may be obtained by performing experiments and storing the experiment results as database in the backup RAM 10d in advance of shipping of the printer. Further, when the processing of FIG. 4 is terminated after the calculation of the color shift amount in S9, the registration marks RM are removed by the cleaning roller 105 at a predetermined timing.

Thus, the registration marks RM are read by the one detection sensor 111 for the plurality of times in the printer 1 by separating the cleaning roller 105 from the sheet conveying belt 6 and rotationally driving the sheet conveying belt 6 to cause at least one rotation of the sheet conveying belt 6. Therefore, the above-described plural times of reading are achieved without using a sensor having a multiple of pixels or forming the registration marks RM repeatedly, and the color shift or the like is excellently detected without increasing a production cost or a running cost of the apparatus.

Though the cleaning roller 015 is separated from the sheet conveying belt 6 in the printer 1 before the formation of the registration marks RM, it is sufficient that the cleaning roller 105 is separated from the sheet conveying belt 6 before the registration marks are faced to the cleaning roller 105. However, the sheet conveying belt 6 can be vibrated when the cleaning roller 105 is separated from the sheet conveying belt 6. Therefore, it is desirable that the cleaning roller 105 is separated from the sheet conveying belt 6 at a timing other than the formation or the reading of the registration marks RM.

Also, as a mode for stopping the function of the cleaning roller 105, various modes other than the above-described one can be employed. For example, it is in some cases possible to prevent the removal of the registration marks only by stopping the bias applied between the electrode roller 104 and the cleaning roller 105. Particularly, in the case of using a toner having a smoother surface, such as a polymerized toner, as the toner T, the removal of the registration marks is satisfactorily prevented only by the stop of bias application since such toner easily slips through the cleaning roller 105.

FIG. 3 is a conceptual diagram for illustrating one example of constitution of a toner elimination unit 100 that enables the above bias adjustment. The toner elimination unit 100 is capable also of removing a negatively charged paper dust 90 from the sheet conveying belt 6 as described below.

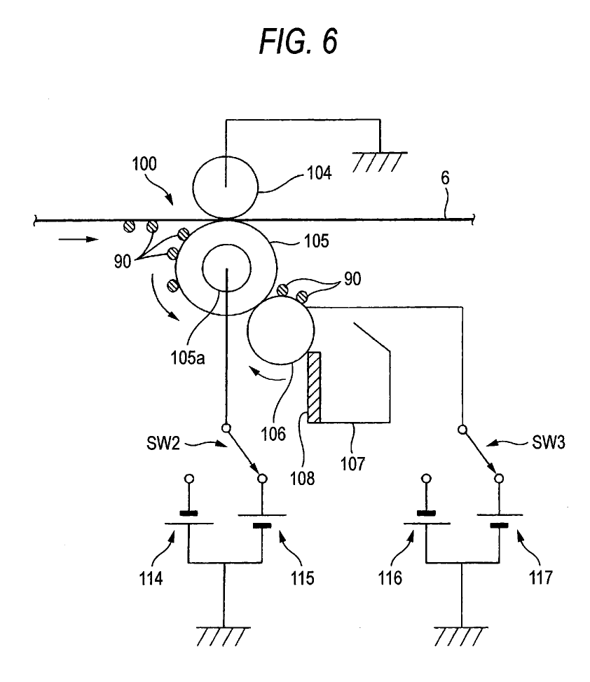

As shown in FIG. 6, the toner removal unit 100 is so formed as to change a polarity of the bias applied to the electrode roller 104 and the cleaning roller 105 in accordance with a switching of a cleaning bias changing switch SW2 (hereinafter simply referred to as SW2). The electrode roller 104 is connected to the ground line to be grounded. The cleaning roller 105 is selectively connected to the constant voltage source 114 or the constant voltage source 115 by the switch SW2.

In the case of removing the paper dust 90 from the sheet conveying belt 6 as shown in FIG. 6, a bias (e.g. +600 V) having a polarity reverse to that of the paper dust 90 is applied from the constant voltage source 115 to the cleaning roller 105. In the case of removing the toner T on the sheet conveying belt 6, a bias (e.g. −1200 V) having a polarity reverse to that of the toner T is applied from the constant voltage source 114 to the cleaning roller 105.

The collection roller 106 abutted to the cleaning roller 105 is rotated by a driving unit (not shown) or a driving of the cleaning roller 105 (interlocking with the cleaning roller 105 due to friction between the cleaning roller 105 and the collection roller 106) in such a fashion that of the cleaning roller 105 and the collection roller 106 rotate in an identical direction and at an identical speed at the contact part, and a bias voltage is applied from constant voltage sources 116 and 117 via a switch SW3 to the collection roller 106. As shown in FIG. 6, in the case of removing paper dust, a bias (e.g. +800 V) having a polarity reverse to that of the paper dust 90 (positive polarity) is applied from the constant voltage source 117 to the collection roller 106. In the case of removing the toner, a bias (e.g. −1600 V) having a polarity reverse to that of the toner T (negative polarity) is applied from the constant voltage source 116 to the collection roller 106.

In either case of the paper dust removal and the toner removal, the bias is so adjusted as to make an attraction force of the collection roller 106 larger than that of the cleaning roller 105, so that the paper dust 90 moves from the cleaning roller 105 to the collection roller 106 in the case of paper dust removal. The paper dust scratched off by the cleaning blade 108 is housed in the retention box 107. Likewise, in the case of the toner removal, the toner T is moved from the cleaning roller 105 to the collection roller 106, and the cleaning blade 108 scratches off the toner T to house the toner T in the retention box 107. The switching between the switches SW2 and SW3 is performed in accordance with control signals sent from the control unit 10 (FIG. 1), and the control unit 10 sends the signals to the switches SW2 and SW3 for switching to the constant voltage sources 115 and 117 in the paper dust removal, while sending the signals to the switches SW2 and SW3 for switching to the constant voltage sources 114 and 116 in the toner removal.

With such constitution of the toner removal unit 100, the positive polarity bias is applied to the cleaning roller 105 in the same manner as in the paper dust removal in place of separating the cleaning roller 105 from the sheet conveying belt 6 in order to stop the function of the cleaning roller 105.

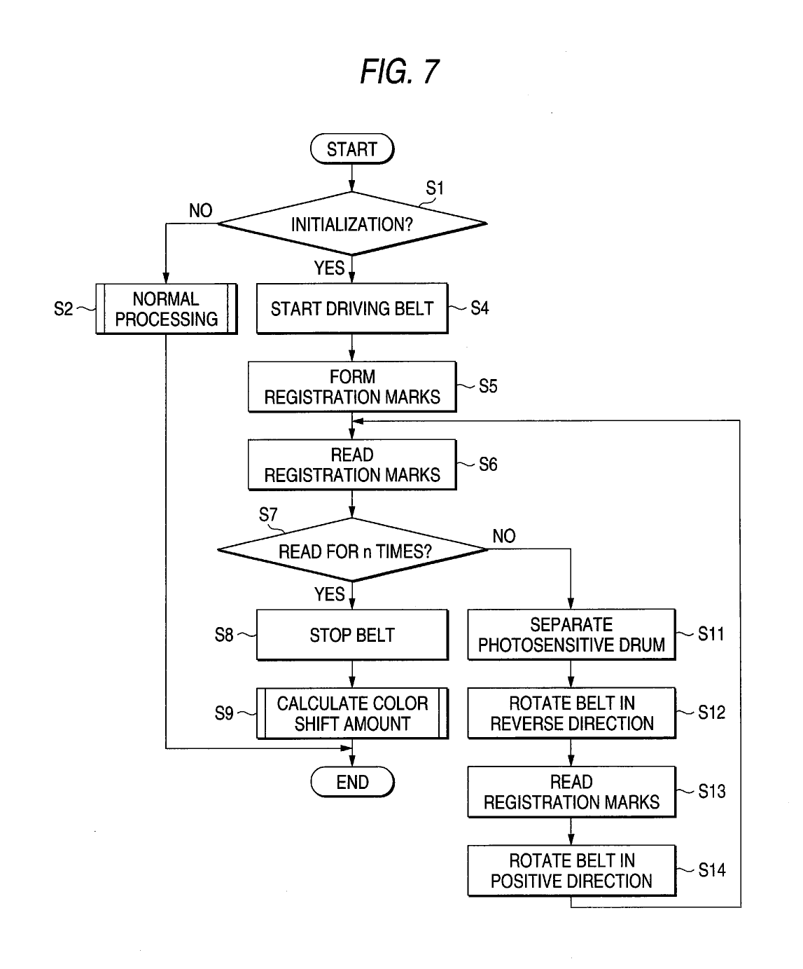

Further, when processing to be performed by the control unit 10 is constituted as follows, it is possible to achieve an effect similar to that described above without stopping the function of the cleaning roller 105. FIG. 7 is a flowchart showing another mode of the processing performed by the control unit 10. In FIG. 7, reference numerals are used for the process steps identical to those shown in FIG. 4 to omit detailed description of the process steps.

As shown in FIG. 7, the process proceeds to S4 without stopping the function of the cleaning roller 105 at the time of initialization (S1: YES) in this processing to start the driving for rotating the sheet conveying belt 6 in the positive rotation direction. The registration marks RM are formed (S5), and the reading of the registration marks RM is terminated (S6). Then, it is judged whether or not the reading was performed for a predetermined times (n times: n>2) (S7), and the process returns to S11 when the reading has not been performed for the n times (S7: NO).

In S11, an instruction signal is sent to the lifting motor 74, so that the four photosensitive drums 3 are separated from the sheet conveying belt 6. In S12, an instruction signal is sent to the belt motor 131 so that the sheet conveying belt 6 is rotated in the reverse direction. Since the sheet conveying belt 6 is started to rotate in the reverse direction immediately after the reading of the registration mark RM by the detection sensor 111, the registration marks RM do not reach the cleaning roller 105 at this time point. Therefore, when the sheet conveying belt 6 is rotated in the reverse direction, the registration marks RM are faced to the detection sensor 111 bypassing above the detection sensor 111 along with the reverse rotation. Therefore, in S13 performed subsequently to S12, the registration marks RM are read again by the detection sensor 111, and then the sheet conveying belt 6 is driven to rotate in the positive direction again in S14 after the reading by the detection sensor 111. The process proceeds to S6 after S14, so that the registration marks RM are read again. Thus, when the registration marks RM have been read for n times (S7: YES), the sheet conveying belt 6 is stopped (S8), and then a color shift amount is calculated (S9) to terminate the processing in the same manner as in the above-described processing.

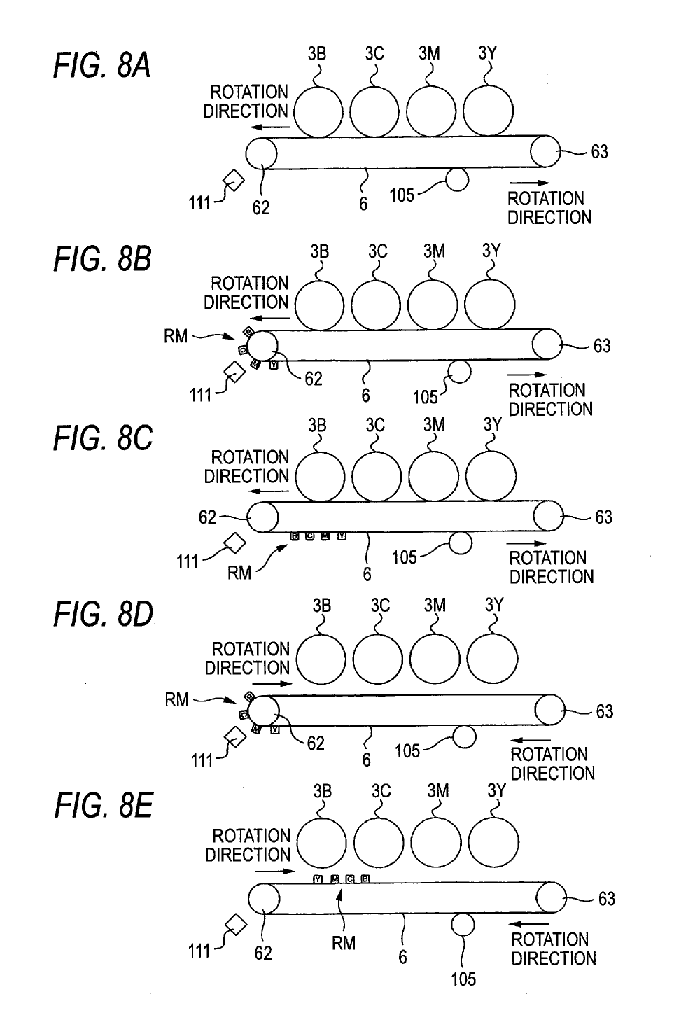

The processing from S4 to S14 will be described by using a block diagram shown in FIGS. 8A to 8E. Operations shown in FIGS. 8A and 8B are the same as those of the foregoing processing except for that the cleaning roller 105 is not separated from the sheet conveying belt 6. That is, as shown in FIG. 8A, the driving of the sheet conveying belt 6 is started (S4), so that as shown in FIG. 8B, the registration marks RM are formed on the surface of the sheet conveying belt 6 (S5). The registration marks RM are then read when they are faced to the detection sensor 111 (S6).

As shown in FIG. 8C, before the registration marks RM reach the cleaning roller 105 after the completion of the reading, the sheet conveying belt 6 is rotated in the reverse direction (S12) as shown in FIG. 8D, so that the registration marks are faced to the detection sensor 111 bypassing above the detection sensor 111 along with the reverse rotation. The registration marks RM are read again when they pass above the detection sensor 111 from the reverse direction (S13). During the reverse rotation, the photosensitive drums 3Y to 3B are separated from the sheet conveying belt 6 (S11). Therefore, it is possible to prevent the photosensitive drums 3 from being damaged by the friction between the sheet conveying belt 6 rotating in the reverse direction and the photosensitive drums 3. This damage prevention can be achieved also by rotating the photosensitive drums 3 in the reverse direction by sending an instruction signal to the drum motor 132.

As shown in FIG. 8E, after the registration marks RM have been faced to the detection sensor 111, the sheet conveying belt 6 is rotated in the positive direction again (S14). Thus, in the same manner as in the above-described processing, the plural times of reading are achieved without using a sensor having a multiple of pixels or forming the registration marks repeatedly, and the color shift or the like is excellently detected without increasing a production cost or a running cost of the apparatus.

Also, since it is possible to read the registration marks RM for the plural times without causing the sheet conveying belt 6 to rotate once in this processing, it is possible to increase a processing speed. Further, since the photosensitive drums 3 are separated from the sheet conveying belt 6, the registration marks are not reversely transferred on the photosensitive drums 3 even when the registration marks are moved to face the photosensitive drums 3, as shown in FIG. 8E.

The function of the cleaning roller 105 may be stopped before the start of the driving of the sheet conveying belt 6 in this processing in the same manner as in the processing S3 of FIG. 4. In this case, the registration marks RM are prevented from being removed even when the registration marks RM are faced to the cleaning roller 105. Further, in the case of stopping the function of the cleaning roller 105, restriction on the position of the cleaning roller 105 is eliminated to enable easy downsizing of the apparatus.

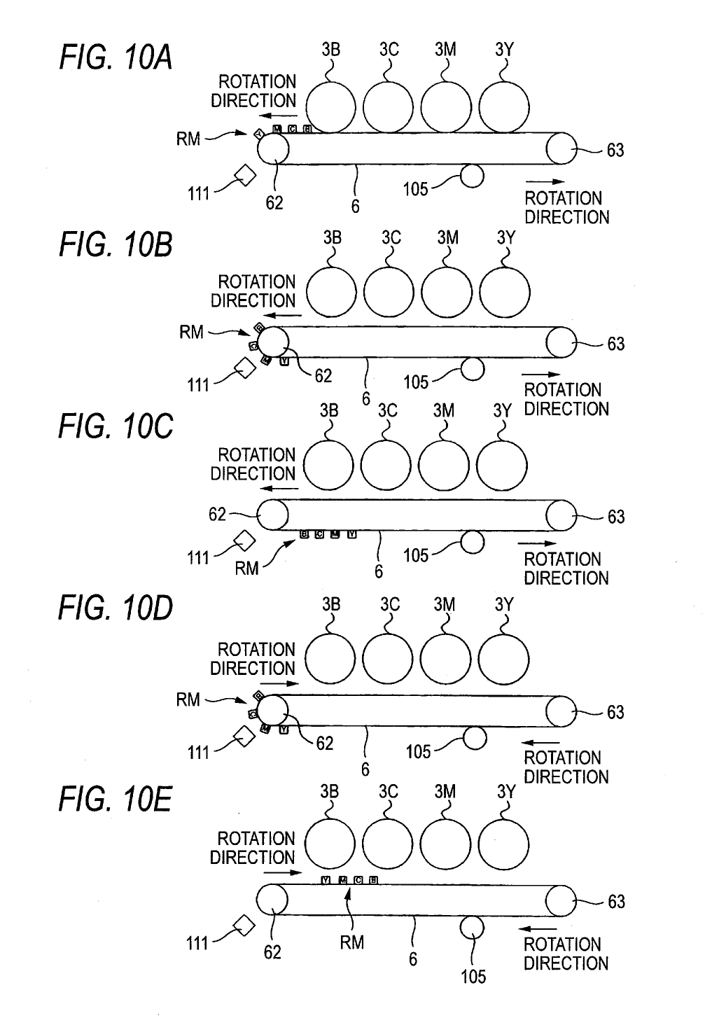

Further, when processing to be performed by the control unit 10 is constituted as follows, it is possible to achieve an effect similar to that described above without stopping the function of the cleaning roller 105. FIG. 10 is a flowchart showing another mode of the processing performed by the control unit 10. In FIG. 10, as in FIG. 7, reference numerals are used for the process steps identical to those shown in FIG. 4 to omit detailed description of the process steps.

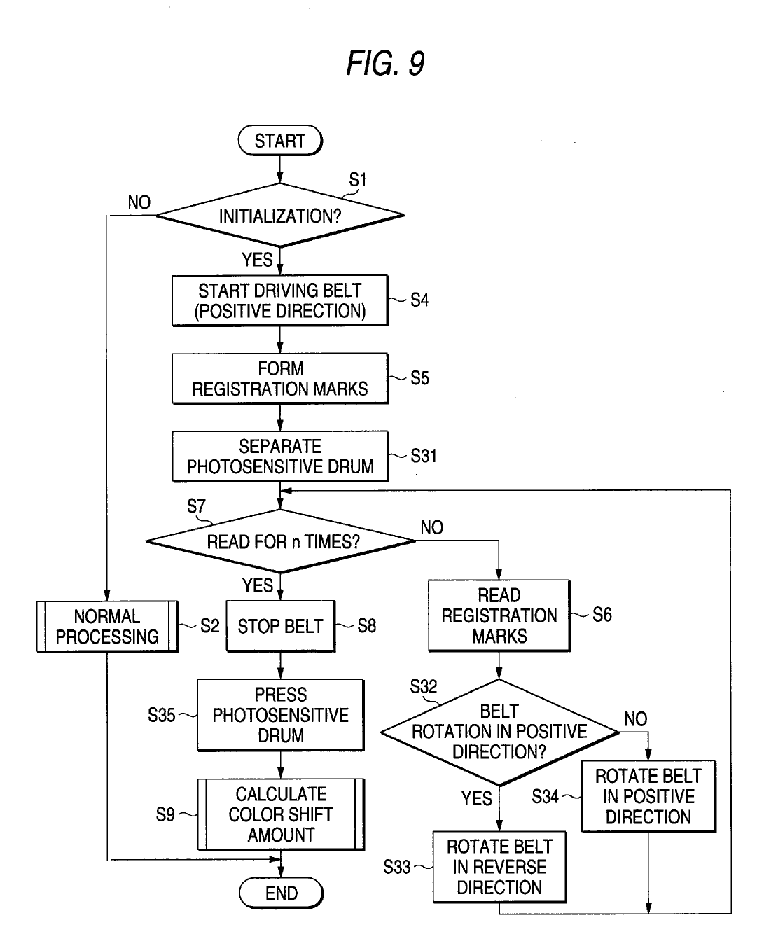

As shown in FIG. 9, the process proceeds to S4 without stopping the function of the cleaning roller 105 at the time of initialization (S1: YES) in this processing to start the driving for rotating the sheet conveying belt 6 in the positive rotation direction. The registration marks RM are formed (S5), an instruction signal is sent to the lifting motor 74, so that the four photosensitive drums 3 are separated from the sheet conveying belt in S31.

When the reading has not been performed for n times in S7 (S7: NO), the reading of the registration marks is performed (S6). After that, in S32, an instruction signal is sent to the belt motor 131 so that the driving direction of the sheet conveying belt 6 is reversed. Here, the reversing the driving direction means changing the belt rotation in the positive direction (S32=YES) to the reverse direction (S34) and changing the belt rotation in the reverse direction (S32=NO) to the positive direction (S34).

Since the driving direction of the belt is reversed immediately after the reading registration mark RM by the detection sensor 111, the registration marks RM do not reach the cleaning roller 105 or the photosensitive drum at this point. When the reading has not been performed for n times in S7 (S7: NO), the sheet conveying belt continue to be driven, and the registration mark RM are faced to the detection sensor 111 by passing above the detection sensor 111 along with the reverse direction. The registration marks RM are read again when they pass above the detection sensor 111 from a direction reverse to that of passing immediately before. The registration marks RM are read through the detection sensor 111, and the reading is terminated. Then, the driving direction of the sheet conveying belt 6 is reversed in S32. Thus, when the registration marks have been read for n times (S7: YES), the sheet conveying belt 6 is stopped (S8) as in the above-described processing, an instruction signal is sent to the lifting motor 74, the four photosensitive drums 3 are pressed onto the sheet conveying belt 6 (S35). Then a color shift amount is calculated (S9), and the processing is terminated.

In the processing shown in FIG. 9, the registration marks may be read arbitrary times larger than zero.

Further, the reading by the detection sensor 111 may be performed only when the belt is driven in the positive direction, and the reading may be performed only when the belt is driven in the reverse direction.

The processing from S4 to S35 will be described by using a block diagram show in FIGS. 10A to 10E. Operations shown in FIGS. 10A and 10B are the same as those of the foregoing processing except for that the cleaning roller 105 is not separated from the sheet conveying belt 6. That is, as shown in FIG. 1A, the driving of the sheet conveying belt 6 is started (S4), so that as shown in FIG. 10B, the registration marks RM are formed on the surface of the sheet conveying belt 6 (S5). The registration marks are then read when they are faced to the detection sensor 111 (S6). After the registration marks RM are formed on the surface of the sheet conveying belt 6, the photosensitive drums 3Y to 3B are separated from the sheet conveying belt 6 (S21). Therefore, it is possible to prevent the photosensitive drums 3 from being damaged by the friction between the sheet conveying belt 6 and the photosensitive drums 3 during reading the registration marks in S6. This damage prevention can be achieved also by rotating the photosensitive drums 3 in the reverse direction by sending an instruction signal to the drum motor 132.

As shown in FIG. 10C, before the registration marks RM reach the cleaning roller 105 after the completion of the reading, the sheet conveying belt 6 is rotated in the reverse direction (S32, S33, S34) as shown in FIG. 10D, so that the rotation marks are faced to the detection sensor 111 by passing above the detection sensor 111 along with the reverse direction. Then, the registration marks RM are read again (S6).

As shown in FIG. 10E, after the registration marks RM have been faced to the detection sensor 111, the sheet conveying belt 6 is rotated in the positive direction again (S32, S33, S34). Thus, in the same manner as in the above-described processing, the plural times of reading are achieved without using a sensor having a multiple of pixels or forming the registration marks repeatedly, and the color shift or the like is excellently detected without increasing a production cost or a running cost of the apparatus.

Also, since it is possible to read the registration marks RM for the plural times without causing the sheet conveying belt 6 to rotate once in this processing, it is possible to increase a processing speed. Further, since the photosensitive drums 3 are separated from the sheet conveying belt 6, the registration marks are not reversely transferred on the photosensitive drums 3 even when the registration marks RM are moved to face the photosensitive drums 3, as shown in FIG. 10E.

The function of the cleaning roller 105 may be stopped before the start of the driving of the sheet conveying belt 6 in this processing in the same manner as in the processing S3 of FIG. 4. In this case, the registration marks RM are prevented from being removed even when the registration marks RM are faced to the cleaning roller 105. Further, in the case of stopping the function of the cleaning roller 105, restriction on the position of the cleaning roller 105 is eliminated to enable easy downsizing of the apparatus.

In each of the above processing, S3 is equivalent to the removal function stopping step, and S4 and S8 or S4, S12, S14, and S8 are equivalent to the driving control step. Also, this invention is not limited to the above-described embodiments, and it is possible to practice various modes insofar as the practices do not deviate from scope of this invention. For example, the registration marks RM may be used for concentration adjustment, positioning, and like image formation state adjustments in addition to the detection of the color shift. Further, in printers where the function of the cleaning roller 105 is normally stopped so that the toner T is removed only in a particular case such as cleaning, it is possible to omit the process step of S3. The photoconductor may be a belt, and the belt member may be a so-called intermediate transfer belt.

What is claimed is:

1. An image forming apparatus comprising:
a photoreceptor which forms an electrostatic image on a surface responsive to light exposure;
a light exposure unit which forms the electrostatic image on the surface of the photoreceptor by exposing the photoreceptor;
a development unit which develops the electrostatic image by depositing a developer on the electrostatic image formed on the surface of the photoreceptor;
a belt member which transfers the developer deposited on the photoreceptor by the developing unit, the belt member being in a form of an endless belt;
a driving unit which rotationally drives the belt member;
a removal unit which removes the developer transferred on the belt member;
a pattern formation unit which forms a pattern on the belt member by controlling the light exposure unit;
a pattern detection unit which detects the pattern formed on the belt member;
a removal function stopping unit which prohibits removing the developer constituting the pattern by stopping a developer removal function of the removal unit before at least the developer constituting the pattern reaches a removal position of the removal unit or by maintaining a state in which the developer removal function is stopped when the pattern is formed on the belt member; and
a drive control unit which causes the pattern passing through a detection area of the detection unit for a plurality of times by controlling the driving unit to rotate the belt member at least once when the pattern is formed on the belt member.

2. The image forming apparatus according to claim 1, wherein:
the drive control unit which causes the pattern detection unit to detect the pattern for a plurality of times by controlling the driving unit to rotate the belt member at least once when the pattern is formed on the belt member.

3. The image forming apparatus according to claim 1, wherein
the removal function stopping unit stops the removal function by separating the removal unit from the belt member or by maintaining a state in which the removal unit is separated from the belt member, or maintains a state in which the removal function is stopped.

4. The image forming apparatus according to claim 3, wherein
the removal function stopping unit separates the removal unit from the belt member at a timing other than a period during the pattern detection by the pattern detection unit.

5. An image forming apparatus comprising:
a photoreceptor which forms an electrostatic image on a surface responsive to light exposure;
a light exposure unit which forms the electrostatic image on the surface of the photoreceptor by exposing the photoreceptor;
a development unit which develops the electrostatic image by depositing a developer on the electrostatic image formed on the surface of the photoreceptor;
a belt member which transfers the developer deposited on the photoreceptor by the developing unit, the belt member being in a form of an endless belt;
a driving unit which rotationally drives the belt member;
a removal unit which removes the developer transferred on the belt member;
a pattern formation unit which forms a pattern on the belt member by controlling the light exposure unit; and
a pattern detection unit which detects the pattern formed on the belt member, wherein
the removal unit is disposed at a position where the removal unit does not start removing the developer constituting the pattern until a pattern detection by the pattern detection unit is completed, and
the image forming apparatus further includes a drive control unit which when the pattern is formed on the belt member controls the driving unit to cause the belt member to rotate in a reverse direction at a timing after the completion of the pattern detection by the pattern detection unit and before the removal unit starts removing the developer constituting the pattern, and to cause the belt member to rotate the belt member in a positive direction after disposing the pattern short of a detection position of the pattern detection unit, thereby causing the pattern detection unit to detect the pattern for a plurality of times.

6. An image forming apparatus comprising:
a photoreceptor which forms an electrostatic image on a surface responsive to light exposure;
a light exposure unit which forms the electrostatic image on the surface of the photoreceptor by exposing the photoreceptor;
a development unit which develops the electrostatic image by depositing a developer on the electrostatic image formed on the surface of the photoreceptor;
a belt member which transfers the developer deposited on the photoreceptor by the developing unit, the belt member being in a form of an endless belt;
a driving unit which rotationally drives the belt member;
a removal unit which removes the developer transferred on the belt member;
a pattern formation unit which forms a pattern on the belt member by controlling the light exposure unit;
a pattern detection unit which detects the pattern formed on the belt member;
a removal function stopping unit which prohibits removing the developer constituting the pattern by stopping a developer removal function of the removal unit before at least the developer constituting the pattern reaches a removal position of the removal unit or by maintaining a state in which the developer removal function is stopped when the pattern is formed on the belt member; and
a drive control unit which when the pattern is formed on the belt member controls the driving unit to cause the belt member to rotate in a reverse direction after the completion of the pattern detection by the pattern detection unit, and to cause the belt member to rotate the belt member in a positive direction after disposing the pattern short of a detection position of the pattern detection unit, thereby causing the pattern detection unit to detect the pattern for a plurality of times.

7. The image forming apparatus according to claim 6, wherein
the removal function stopping unit stops the removal function by separating the removal unit from the belt member or by maintaining a state in which the removal unit is separated from the belt member, or maintains a state in which the removal function is stopped.

8. The image forming apparatus according to claim 7, wherein
the removal function stopping unit separates the removal unit from the belt member at a timing other than a period during the pattern detection by the pattern detection unit.

9. The image forming apparatus according to claim 5, further comprising:
a detaching unit which detaches the photoreceptor from the belt member when the drive control unit causes the belt member to rotate in the reverse direction.

10. The image forming apparatus according to claim 6, further comprising:
a detaching unit which detaches the photoreceptor from the belt member when the drive control unit causes the belt member to rotate in the reverse direction.

11. The image forming apparatus according to claim 5, further comprising:
a photoreceptor reverse rotation unit which rotates the photoreceptor in the reverse direction when the drive control unit causes the belt member to rotate in the reverse direction.

12. The image forming apparatus according to claim 6, further comprising:
a photoreceptor reverse rotation unit which rotates the photoreceptor in the reverse direction when the drive control unit causes the belt member to rotate in the reverse direction.

13. The image forming apparatus according to claim 5, wherein
the pattern detection unit detects the pattern during the drive control unit causes the belt member to rotate in the reverse direction.

14. The image forming apparatus according to claim 6, wherein
the pattern detection unit detects the pattern during the drive control unit causes the belt member to rotate in the reverse direction.
